(19) United States
(12) Patent Application Publication
(10) Pub. No.: US 2025/0011515 A1
(43) Pub. Date: Jan. 9, 2025

(54) REGULATION METHOD OF MOLECULAR WEIGHT FOR PREPARATION OF SYNDIOTACTIC 1,2-POLYBUTADIENE USING AN IRON-BASED CATALYST

(71) Applicant: QINGDAO UNIVERSITY OF SCIENCE AND TECHNOLOGY, Qingdao (CN)

(72) Inventors: Chunyu ZHANG, Qingdao (CN); Shiliang XU, Qingdao (CN); Yao YU, Qingdao (CN); Heng LIU, Qingdao (CN); Xuequan ZHANG, Qingdao (CN)

(73) Assignee: QINGDAO UNIVERSITY OF SCIENCE AND TECHNOLOGY, Qingdao (CN)

(21) Appl. No.: 18/751,843

(22) Filed: Jun. 24, 2024

(30) Foreign Application Priority Data
Jul. 3, 2023 (CN) 202310803768.1

(51) Int. Cl. C08F 236/06

(52) U.S. Cl. CPC C08F 236/06

(57) ABSTRACT

Disclosed is a method of adjusting the molecular weight of syndiotactic 1,2-polybutadiene prepared using an iron-based catalyst. In the present application, when an iron-based catalyst catalyzes the polymerization of butadiene to prepare syndiotactic 1,2-polybutadiene, alpha-olefins are added as a molecular weight regulator, and a chain transfer effect is achieved through competitive adsorption. At the same time, since alpha-olefins are stable to iron-based catalysts, cannot be initiated to polymerize, and are easy to separate from butadiene, they have a significant effect on molecular weight regulation and do not have a significant effect on activity, making it possible to prepare syndiotactic 1,2-polybutadiene thermoplastic elastomers with number average molecular weights ranging from 3,000-250,000. The syndiotactic 1,2-polybutadiene rubber prepared by the present application has better processability. The present application has the advantages of low attenuation of iron-based catalyst activity, a broad range of molecular weight adjustment and facile butadiene separation.

### CROSS-REFERENCE TO RELATED APPLICATIONS

This application claims priority to Chinese Patent Application No. 202310803768.1, filed on Jul. 3, 2023, the content of which is incorporated herein by reference in its entirety.

### TECHNICAL FIELD

The present application relates to the technical field of syndiotactic 1,2-polybutadiene preparation, and specifically relates to a regulation method of molecular weight for preparation of syndiotactic 1,2-polybutadiene using an iron-based catalyst.

### BACKGROUND

Syndiotactic 1,2-polybutadiene thermoplastic elastomer (SPB) is an easily vulcanizable high-hardness rubber material that is superior to high-styrene styrene-butadiene rubber (the existing high-hardness rubber material) in a number of aspects such as elongation, permanent deformation, resistance to flexing, abrasion, weathering, ozone, and heat aging, as well as stiffness and elasticity. Syndiotactic 1,2-polybutadiene elastomers were first prepared by JSR Corporation in 1966 using a cobalt-based catalyst (CoX2-AlR3-H2O/Ph3P) in a halogenated alkane solvent with triphenylphosphine (Ph3P), trimethylphenylphosphine (MePh3P), and other electron-donors. The syndiotactic 1,2-polybutadiene elastomers produced by this catalyst system have a crystallinity of 15-25% and a melting point of 75-90° C. This product was industrialized in 1974 under the trade name JSR RB Series, and is mainly available in grades RB805, 810, 820, and 830. (ACS Symposiums Series 4:15, 1974. Japan Rubber Association Journal, 52(8):481-492, 1979).

In the 1970s, another cobalt-based catalyst (Co(acac)3-AlEt3-CS2) was developed by UBE Corporation in Japan, which used carbon disulfide as the electron donor and aromatic hydrocarbons as the solvent to produce syndiotactic 1,2-polybutadiene with high crystallinity and high melting point (Tm>200° C.), and this was applied as a feedstock in the manufacture of carbon fibers (J. Polym. Sci. Polym Chem Ed, 1983, 21; 1853-1860. 1984, 29:2763). Meanwhile, UBE also developed new types of cis-1,4-polybutadiene rubber modified by syndiotactic 1,2-polybutadiene with high crystallinity and high melting point, namely Ubepol-VCR309 (non-tire type) and Uubpol-VCR412 (tire type).

Although industrial production of syndiotactic 1,2-polybutadiene prepared with cobalt compounds as catalysts has been achieved, the polymerization process requires the utilization of carbon disulfide as the electron donor, which emits a pungent odor, and the use of toxic, environmentally hazardous solvents, such as haloalkanes and aromatic hydrocarbons that pose great threats to both the environment and human health and safety while also increasing the production cost. These drawbacks have largely limited the application and development of cobalt-based syndiotactic 1,2-polybutadiene.

Iron-based catalysts are non-toxic, green, environmentally friendly, biocompatible, inexpensive and easy to obtain. Moreover, iron-based catalysts can catalyze butadiene to polymerize in aliphatic hydrocarbon solvents without the use of toxic electron-donating reagents such as carbon disulfide and solvents such as dichloromethane and benzene, which are harmful to the environment and human health, so they have obvious advantages in terms of environmental protection and cost effectiveness when compared with cobalt-based catalyst systems. Brigestone Corporation in Japan recently developed an iron-based catalyst with the addition of dialkyl phosphite [HP(O)(OR)2] or cyclic phosphite as the electron donor and using aliphatic hydrocarbons as the solvent to produce high crystallinity syndiotactic 1,2-polybutadiene with a melting temperature of 160° C.-180° C. (EP0994129A1, EP0994130A, U.S. Pat. No. 627,779, WO0149753A1). The dialkyl phosphite used in the catalyst is not only an intermediate in the preparation of pesticides, which decomposes easily in contact with water to release toxic and health-hazardous phosphorus oxide fumes, but also a chemical subject to transportation restrictions. This also affects the wide application of this catalyst system to a certain extent. At the same time, the syndiotactic 1,2-polybutadiene thermoplastic elastomer prepared by this catalytic system forms a pseudo-gel-like substance during polymerization, so that the uniform dispersal of the antioxidant into the polymer is difficult to achieve during processing, which can lead to gelation of the polymer during post-treatment and processing. In order to solve the problem of hydrolysis of dialkyl phosphates, Zhang Xuequan et al. developed a systematic catalyst system with a less toxic and stable diaryl phosphite or aryl phosphate reagent as ligand (CN1260259C). To solve the gelation problem Brigestone used polymerization at high temperature (80° C.) and the addition of antioxidant 2,6-dihydrocarbyl-4-(dialkyl aminomethyl)phenol (US 2003/0040594A1); while Zhang Xuequan et al. used the system of ferric isooctanoate/diphosphite/trialkyl aluminum, with the addition of 2,6-dihydrocarbyl-4-(dialkyl aminomethyl) phenol, as a catalyst to prepare thermally stabilized syndiotactic 1,2-polybutadiene thermoplastic elastomers.

Although the above iron-based catalysts can produce syndiotactic 1,2-polybutadiene elastomers and the polymerization activity of the catalyst system is high, there are still the following problems: the molecular weight of the syndiotactic 1,2-polybutadiene elastomers produced by iron-based catalysts is high, and their melting point can be more than 170° C., and the high molecular weight and high melting point cause the problem of not being able to be mixed uniformly when mixing with other rubbers.

Existing iron-based catalyst systems for the preparation of syndiotactic 1,2-polybutadiene suffer from high and unregulated molecular weights of their products, while the catalysts are easily reduced to inactive zero-valent iron due to the instability of the Fe—H bond. Therefore, iron catalysts cannot regulate molecular weight with hydrogen like polyolefin catalysts, nor can they regulate molecular weight using aluminium hydride like rare earth catalysts and nickel catalysts, so molecular weight regulation has been a problem to be solved for iron-based catalysts.

### SUMMARY

In order to solve the deficiencies of the existing technology, the present application provides a regulation method of molecular weight for preparation of syndiotactic 1,2-polybutadiene using an iron-based catalyst.

In order to achieve the above purpose, the technical solution of the present application is as follows: a regulation method of molecular weight for preparation of syndiotactic 1,2-polybutadiene using an iron-based catalyst, comprising the steps of: mixing butadiene with an iron-based catalyst and alpha-olefins and carrying out a polymerization reaction to obtain the aforementioned syndiotactic 1,2-polybutadiene.

Furthermore, the iron-based catalyst comprises aliphatic hydrocarbon-soluble transition metal iron element organic compounds, electron-donor compounds, and alkyl aluminum compounds.

Furthermore, the aliphatic hydrocarbon-soluble transition metal iron element organic compounds comprise carboxylate salts and compounds of divalent or trivalent iron.

Furthermore, the carboxylate salts and compounds of divalent or trivalent iron comprise one or more of the following: ferric acetylacetonate, ferric naphthenate, ferric neodecanoate, and ferric isooctanoate.

Furthermore, the electron-donor compounds comprise one or more of the following: diethyl phosphite, triphenyl phosphate, azobisisobutyronitrile, 2,2′-azobisisoheptonitrile, (isocyanimino)triphenylphosphorane.

Furthermore, the alkyl aluminum compounds comprise one or more of the following: triethyl aluminum, triisobutyl aluminum, diisobutyl aluminum hydride, and diisobutyl aluminum chloride.

Furthermore, the alpha-olefins are alpha-olefins having a carbon atom number of 2-20.

Furthermore, the alpha-olefins comprise one or more of the following: ethylene, propylene, 1-butene, 1-pentene, 1-hexene, and 1-octene.

Furthermore, weight ratio of the alpha-olefins to butadiene is 0.001-1000.

Furthermore, the butadiene is dissolved in alpha-olefins or a hydrocarbon solvent prior to polymerization, and the hydrocarbon solvent comprises one or more of the following: benzene, toluene, xylene, hexane, cyclohexane, pentane, heptane, and octane.

The beneficial effects achieved by the present application are as follows.

In the present application, when an iron-based catalyst catalyzes the polymerization of butadiene to prepare syndiotactic 1,2-polybutadiene, alpha-olefins are added as a molecular weight regulator, and a chain transfer effect is achieved through competitive adsorption. At the same time, since alpha-olefins are stable to iron-based catalysts, cannot be initiated to polymerize, and are easy to separate from butadiene, they have a significant effect on molecular weight regulation and do not have a significant effect on activity, making it possible to prepare syndiotactic 1,2-polybutadiene thermoplastic elastomers with number average molecular weights ranging from 3,000-250,000. Compared with the existing syndiotactic 1,2-polybutadiene thermoplastic elastomers with molecular weights of 350,000-600,000, the syndiotactic 1,2-polybutadiene rubber prepared by the present application has better processability. The present application has the advantages of low attenuation of iron-based catalyst activity, broad range of molecular weight adjustment and facile butadiene separation.

### DETAILED DESCRIPTION OF THE EMBODIMENTS

In order to make the objects, technical solutions and advantages of the present application clearer and more understandable, the present application is described in further detail hereinafter in connection with embodiments. It should be understood that the specific embodiments described herein are only for explaining the present application and are not intended to limit the present application.

The experimental methods used in the following embodiments are conventional if not specifically described. The materials, reagents, methods and apparatus used are conventional in the field unless otherwise specified, and are commercially available to those skilled in the art.

The terms “comprising,” “including,” “having,” “containing,” or any other variation thereof, as used in the following embodiments, are intended to cover non-exclusive inclusion. or any other variant thereof, is intended to cover non-exclusive inclusion. For example, a composition, step, method, article or device comprising the listed elements need not be limited to those elements, but may include other elements that are not expressly listed or that are inherent to such composition, step, method, article or device.

When an equivalent, concentration, or other value or parameter is expressed as a range, a preferred range, or a range bounded by a series of upper preferred values and lower preferred values, this should be understood as specifically disclosing all ranges formed by any pairing of any upper preferred value of the range with any lower preferred value of the range, regardless of whether the range is disclosed separately. For example, when the range “1 to 5” is disclosed, the described range should be construed as including the ranges “1 to 4”, “1 to 3”, “1 to 2”, “1 to 2 and 4 to 5”, “1 to 3 and 5”, and the like. When a range of values is described herein, the range is intended to include the end values thereof and all integers and fractions within the range, unless otherwise stated. In this application's specification and claims, range limitations may be combined and/or interchanged, and if not otherwise stated these ranges include all sub-ranges contained therein.

The indefinite articles “one” and “a” before the elements or components of the present application are not restrictive as to the quantitative requirements (i.e. number of occurrences) of the elements or components. Thus “one” or “a” should be read as including one or at least one, and elements or components in the singular form include the plural form as well, unless it is clear that the stated number refers only to the singular form.

### Embodiment 1

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of diethylphosphite, 0.4625 mmol of triisobutyl aluminum (TIBA). Subsequently, 0.1 g of ethylene was introduced before putting the flask into a water bath at a constant temperature of 70° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 2

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of diethylphosphite, 0.4625 mmol of triisobutyl aluminum (TIBA). Subsequently, 0.4 g of ethylene was introduced before putting put the flask into a water bath at a constant temperature of 70° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 3

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of diethylphosphite, 0.4625 mmol of triisobutyl aluminum (TIBA). Subsequently, 0.8 g of ethylene was introduced before putting the flask into a water bath at a constant temperature of 70° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 4

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of (isocyanimino)triphenylphosphorane, 0.37 mmol of triisobutyl aluminum (TIBA). Subsequently, 1 g of ethylene was introduced before putting the flask into a water bath at a constant temperature of 80° C. for polymerization to proceed for 0.5 hour, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 5

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of azobisisobutyronitrile, 0.4625 mmol of triethyl aluminum. Subsequently, 2 g of propylene were introduced before putting the flask into a water bath at a constant temperature of 50° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 6

Under the protection of nitrogen, 84 ml of dry 1-hexene and 10 g of dry butadiene were added into an oven-dried single-necked 120 ml reaction flask. The following reagents were sequentially added: 0.0185 mmol of ferric acetylacetonate, 0.037 mmol of azobisisobutyronitrile, 0.4625 mmol of triethyl aluminum. Subsequently, the flask was put into a water bath at a constant temperature of 50° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 7

Under the protection of nitrogen, 84 ml of dry 1-hexene and 10 g of dry butadiene were added into an oven-dried single-necked 120 ml reaction flask. The following reagents were sequentially added: 0.0925 mmol of ferric acetylacetonate, 0.185 mmol of diethylphosphite, 2.775 mmols of diisobutyl aluminum hydride. Subsequently, the flask was put into a water bath at a constant temperature of 70° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 8

Under the protection of nitrogen, 84 ml of dry 1-hexene and 5 g of dry butadiene were added into an oven-dried single-necked 120 ml reaction flask. The following reagents were sequentially added: 0.0925 mmol of ferric acetylacetonate, 0.185 mmol of diethyl phosphite, 1.85 mmol of triethyl aluminum. Subsequently, the flask was put into a water bath at a constant temperature of 80° C. for polymerization to proceed for 4 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 9

Under the protection of nitrogen, 84 ml of dry 1-octene and 2 g of dry butadiene were added into an oven-dried single-necked 120 ml reaction flask. The following reagents were sequentially added: 0.0185 mmol of ferric acetylacetonate, 0.037 mmol of diethylphosphite, 1.85 mmol of triethyl aluminum. Subsequently, the flask was put into a water bath at a constant temperature of 80° C. for polymerization to proceed for 4 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 10

Under the protection of nitrogen, 84 ml of dry methylbenzene and 8 g of dry butadiene were added into an oven-dried single-necked 120 ml reaction flask. The following reagents were sequentially added: 0.0185 mmol of ferric naphthenate, 0.037 mmol of triphenyl phosphate, 1.85 mmols of triisobutyl aluminum. Subsequently, 1 g of 1-butene was introduced before putting the flask into a water bath at a constant temperature of 70° C. for polymerization to proceed for 4 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 11

Under the protection of nitrogen, 84 ml of dry cyclohexane and 10 g of dry butadiene were added into an oven-dried single-necked 120 ml reaction flask. The following reagents were sequentially added: 0.0185 mmol of ferric neodecanoate, 0.037 mmol of 2,2′-azobisisoheptonitrile, 1.85 mmol of triethyl aluminum. Subsequently, 1 g of 1-pentene was introduced before putting the flask into a water bath at a constant temperature of 80° C. for polymerization to proceed for 4 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Embodiment 12

Under the protection of nitrogen, 84 ml of dry toluene and 10 g of dry butadiene were added into an oven-dried single-necked 120 ml reaction flask. The following reagents were sequentially added: 0.0185 mmol of ferric isooctanoate, 0.037 mmol of 2,2′-azobisisoheptonitrile, 1.85 mmols of triethyl aluminum. Subsequently, 0.5 g of 1-hexene was introduced before putting the flask into a water bath at a constant temperature of 80° C. for polymerization to proceed for 4 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Comparison Example 1

Under the protection of nitrogen, add 84 ml of dry hexane and 10 g of dry butadiene were added into an oven-dried single-necked 120 ml reaction flask. The following reagents were sequentially added: 0.0185 mmol of ferric isooctanoate, 0.037 mmol of AIBN, 0.37 mmol of triisobutyl aluminum (TIBA). Subsequently, the flask was put into a water bath at a constant temperature of 50° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Comparison Example 2

Under the protection of nitrogen, 84 ml of dry hexane and 10 g of dry butadiene were added into an oven-dried single-necked 120 ml reaction flask. The following reagents were sequentially added: 0.0185 mmol of ferric isooctanoate, 0.037 mmol of diethylphosphite, 0.37 mmol of triisobutyl aluminum. Subsequently, the flask was put into a water bath at a constant temperature of 70° C. for polymerization to proceed for 2 hours, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

### Comparison Example 3

Under the protection of nitrogen, 84 ml of dry hexane and 10 g of dry butadiene were added into an oven-dried single-necked 120 ml reaction flask. The following reagents were sequentially added: 0.0185 mmol of ferric isooctanoate, 0.037 mmol of (isocyanimino)triphenylphosphorane, 0.37 mmol of triisobutyl aluminum (TIBA). Subsequently, the flask was put into a water bath at a constant temperature of 80° C. for polymerization to proceed for 0.5 hour, after which time a 1% HCl alcohol solution was added to terminate the polymerization process. The solvent was filtered off and the remaining substance was put in a vacuum drying oven for evacuation and drying to obtain a polymer sample. The experimental results are shown in Table 1.

TABLE 1
Molecular weight and melting point of polymers

| Embodiments | Yield | Mn (×10⁴) | PDI | Tₘ (° C.) | X_{C} (%) |
|---|---|---|---|---|---|
| Embodiment 1 | 99.4 | 24.11 | 2.66 | 131.0 | 33.0 |
| Embodiment 2 | 93.6 | 20.34 | 2.90 | 111.6 | 24.0 |
| Embodiment 3 | 94.5 | 16.35 | 2.88 | 94.7 | 15.7 |
| Embodiment 4 | 96.4 | 10.2 | 2.15 | 80.9 | 15.3 |
| Embodiment 5 | 94.5 | 19.12 | 2.68 | 100.9 | 11.0 |
| Embodiment 6 | 92.1 | 8.2 | 2.90 | 80.3 | 9.8 |
| Embodiment 7 | 89.3 | 2.96 | 2.88 | 81.4 | 5.4 |
| Embodiment 8 | 94.5 | 0.32 | 2.15 | — | — |
| Embodiment 9 | 88.5 | 0.62 | 2.32 | — | — |
| Embodiment 10 | 89.5 | 5.35 | 2.83 | 125.2 | 15.6 |
| Embodiment 11 | 76.5 | 9.23 | 2.36 | 80.3 | 3.5 |
| Embodiment 12 | 90.2 | 11.32 | 2.55 | 82.6 | 6.4 |
| Comparison | 99.5 | 68.2 | 2.60 | 122.1 | 20.2 |
| Example 1 | | | | | |
| Comparison | 96.3 | 35.4 | 2.29 | 172.1 | 66.6 |
| Example 2 | | | | | |
| Comparison | 96.4 | 43.8 | 2.05 | 127.9 | 12.8 |
| Example 3 | | | | | |

It is understood that the present application is described by way of a number of embodiments, and it is known to those skilled in the art that various changes or equivalent substitutions can be made to these features and embodiments without departing from the spirit and scope of the present application. Further, under the teachings of the present application, these features and embodiments may be modified to accommodate specific situations and materials without departing from the spirit and scope of the present application. Accordingly, the present application is not limited by the specific embodiments disclosed herein, and all embodiments falling within the scope of the claims of the present application fall within the scope protected by the present application.

What is claimed is:

1. A regulation method of molecular weight for preparation of syndiotactic 1,2-polybutadiene using an iron-based catalyst, comprising:
mixing butadiene with an iron-based catalyst and alpha-olefins and carrying out a polymerization reaction to obtain the aforementioned syndiotactic 1,2-polybutadiene.

2. The regulation method according to claim 1, wherein a weight ratio of the alpha-olefins to butadiene is 0.001-1000.

3. The regulation method according to claim 1, wherein the butadiene is dissolved in alpha-olefins or a hydrocarbon solvent prior to polymerization, and the hydrocarbon solvent comprises one or more of the following: benzene, toluene, xylene, hexane, cyclohexane, pentane, heptane, and octane.

4. The regulation method according to claim 1, wherein the iron-based catalyst comprises aliphatic hydrocarbon-soluble transition metal iron element organic compounds, electron-donor compounds, and alkyl aluminum compounds.

5. The regulation method according to claim 4, wherein the electron-donor compounds comprise one or more of the following: diethyl phosphite, triphenyl phosphate, azobisisobutyronitrile, 2,2′-azobisisoheptonitrile, (isocyanimino)triphenylphosphorane.

6. The regulation method according to claim 4, wherein the alkyl aluminum compounds comprise one or more of the following: triethyl aluminum, triisobutyl aluminum, diisobutyl aluminum hydride, and diisobutyl aluminum chloride.

7. The regulation method according to claim 4, wherein the aliphatic hydrocarbon-soluble transition metal iron element organic compounds comprise carboxylate salts and compounds of divalent or trivalent iron.

8. The regulation method according to claim 7, wherein the carboxylate salts and compounds of divalent or trivalent iron comprise one or more of the following: ferric acetylacetonate, ferric naphthenate, ferric neodecanoate, and ferric isooctanoate.

9. The regulation method according to claim 1, wherein the alpha-olefins are alpha-olefins having a carbon atom number of 2-20.

10. The regulation method according to claim 9, wherein the alpha-olefins comprise one or more of the following: ethylene, propylene, 1-butene, 1-pentene, 1-hexene, and 1-octene.
